(19) United States
(12) Patent Application Publication
(10) Pub. No.: US 2026/0212025 A1
(43) Pub. Date: Jul. 23, 2026

(54) LLM-BASED CONTEXTUAL MAPPING FOR APPLICATION SECURITY TESTING WITH AUTOMATED TEST GENERATION

(71) Applicant: Wallarm Inc., San Francisco, CA (US)

(72) Inventor: Ivan Novikov, San Francisco, CA (US)

(21) Appl. No.: 19/451,964

(22) Filed: Jan. 16, 2026

Related U.S. Application Data
(60) Provisional application No. 63/746,805, filed on Jan. 17, 2025.

(51) Int. Cl. G06F 21/57; G06Q 10/0875

(52) U.S. Cl. CPC G06F 21/577; G06Q 10/0875; G06F 2221/033

(57) ABSTRACT

A computer-implemented method for application security analysis includes ingesting application data including source code and configuration information, processing the data with a large language model to derive a contextual mapping between external interfaces and internal code portions, identifying security vulnerabilities based on the mapping, associating each vulnerability with at least one mapped code portion and an external interface capable of reaching that portion, automatically generating executable security tests from those associations, executing the tests to produce validation outcomes, and updating at least a portion of the contextual mapping responsive to the outcomes. In certain embodiments, the method accepts user input to refine the mapping and supports export of tests to multiple frameworks, enabling repeatable validation and remediation across evolving deployments.

### RELATED APPLICATIONS

This application is a non-provisional patent application of and claims priority to U.S. Provisional Application No. 63/746,805, filed 17 Jan. 2025, which is incorporated herein by reference in its entirety.

### FIELD OF THE INVENTION

The present invention relates to methods and systems for using large language models (LLMs) to map and/or analyze software functions and/or instructions in security and other applications.

### BACKGROUND

Traditional Static Application Security Testing (SAST) and Interactive Application Security Testing (IAST) tools suffer from limited coverage, and they rarely provide clear coverage reports. They do not let users perform a deep manual dive into their algorithms or internal processes. Security auditors lack proper whitebox analysis capabilities, resulting in high false positive rates and missed vulnerabilities. These solutions often serve only as checkbox compliance tools rather than aiding in serious code hardening, threat prevention, runtime defense, or zero-day mitigation. In many cases, they are not even leveraged during code reviews, where their potential would be most evident.

Another concern is their minimal reusability for improving new code. Many solutions fail to generate relevant security tests from discovered vulnerabilities, preventing developers from using those findings to avoid future threats.

### SUMMARY OF THE INVENTION

In various embodiments, a computer-implemented method for application security analysis may ingest application data that includes at least one of source code and configuration information, process the data with a large language model to derive a contextual mapping between external interfaces of the application and internal code portions, identify security vulnerabilities based on the mapping, associate each identified vulnerability with at least one mapped code portion and at least one external interface capable of reaching that portion, automatically generate executable security tests based at least in part on those associations, execute the tests to produce validation outcomes, and update at least a portion of the contextual mapping responsive to the outcomes. This sequence may provide a reachability-grounded workflow that ties discovered issues to concrete code segments and external entry points suitable for reproducible validation.

In some embodiments, deriving the contextual mapping may include associating functions, classes, logical blocks, or individual lines of code with addressable endpoints or other external interfaces, such as Representational State Transfer (REST), Graph Query Language (GraphQL), gRPC Remote Procedure Calls (gRPC), WebSockets, or Simple Object Access Protocol (SOAP) routes. The mapping may capture gating conditions including validations, role or permission checks, and branching logic that influence traversal from an external interface to a target code portion, and may accept user input to adjust or refine associations so that coverage fidelity adapts to domain-specific frameworks and deployment practices.

In further embodiments, identifying security vulnerabilities may include detecting patterns indicative of insecure logic (e.g., unsanitized inputs, unsafe deserialization, insecure file operations, or outdated cryptographic usage). The method may enumerate dependencies referenced by the application and may generate a software bill of materials, and items in the software bill of materials (SBOM) may be cross-referenced against vulnerability sources such as common vulnerabilities and exposures (CVE) and common platform enumeration (CPE) data to surface known issues. Associations between vulnerabilities, mapped code portions, and external interfaces may be used to establish exploit paths and to prioritize findings by reachability and impact.

Test generation may produce executable artifacts that reproduce an exploit path reachable via at least one external interface, and the artifacts may include minimal exploitable payloads selected to confirm vulnerabilities while reducing false positives. The tests may be exportable to multiple frameworks, including Python-based and Java-based frameworks, and may be integrated into continuous integration and continuous delivery (CI/CD) pipelines for repeatable execution. Validation outcomes may include pass-or-fail indicators and traces that corroborate traversal through gating conditions, and those outcomes may be recorded alongside code changes to support iterative remediation.

In certain embodiments, runtime processes may be instrumented to collect telemetry such as function-call traces, memory-access patterns, resource-usage signals, or endpoint triggers. Telemetry may be correlated with the contextual mapping and validation outcomes to detect anomalies indicative of suspicious or malicious behavior, and policy-based interventions may be initiated when thresholds are met, for example alerting a security control, quarantining a process or container, or blocking invocation of an external interface. Runtime intelligence may be fed back to refine the contextual mapping and to generate additional or revised tests for code paths observed at runtime but absent or under-covered in static analysis, thereby maintaining alignment between static analysis and observed behavior across evolving deployments.

In one aspect, the application data may span multiple microservices implemented in different programming languages, and the contextual mapping may correlate cross-service call flows with corresponding external interfaces. This context-aware correlation may improve end-to-end visibility across heterogeneous components and may facilitate validation sequences that traverse service boundaries while remaining tied to concrete code segments.

These and other embodiments of the invention are more fully described in association with the drawings below.

### BRIEF DESCRIPTION OF THE DRAWINGS

The invention is now described, by way of example and without limiting the scope of the invention, with reference to the accompanying drawings which illustrate embodiments of it, in which:

FIG. 1 depicts an example user workflow with phase validation and coverage adjustments for analyzing code and configurations, generating and validating exploit tests, and aligning runtime monitoring, in accordance with one embodiment of the present invention.

FIG. 2 depicts a vulnerability-assessment and test-generation workflow with user-driven refinement, including coverage updates, dependency analysis, exploit-path construction, and validation, in accordance with one embodiment of the present invention.

FIG. 3 depicts a flowchart of a computer-implemented method for analyzing an application to improve security using a contextual mapping between external interfaces and internal code portions, in accordance with one embodiment of the present invention.

FIG. 4 depicts components of a computer system in which computer readable instructions instantiating the methods of the present invention may be stored and executed.

### DETAILED DESCRIPTION

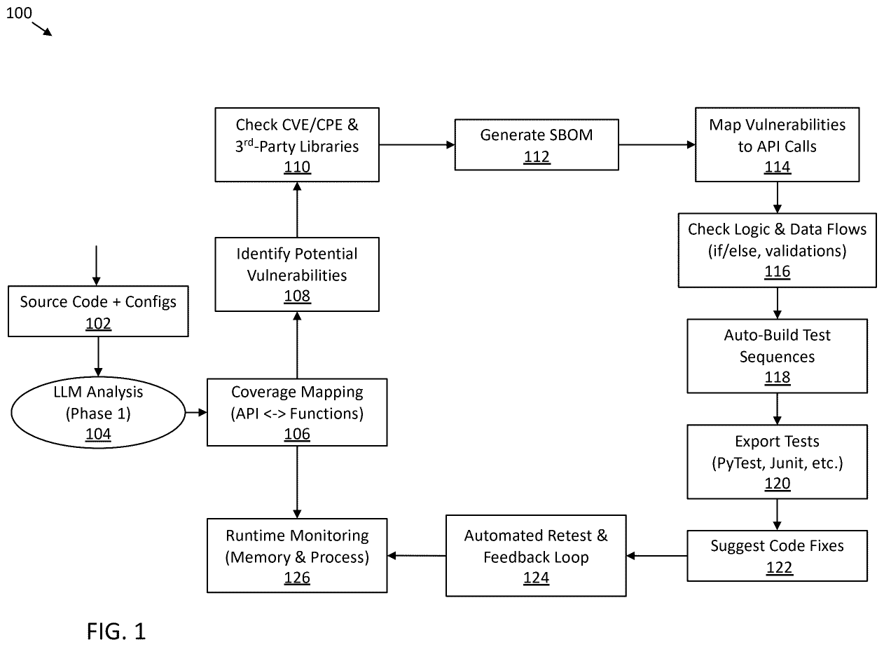

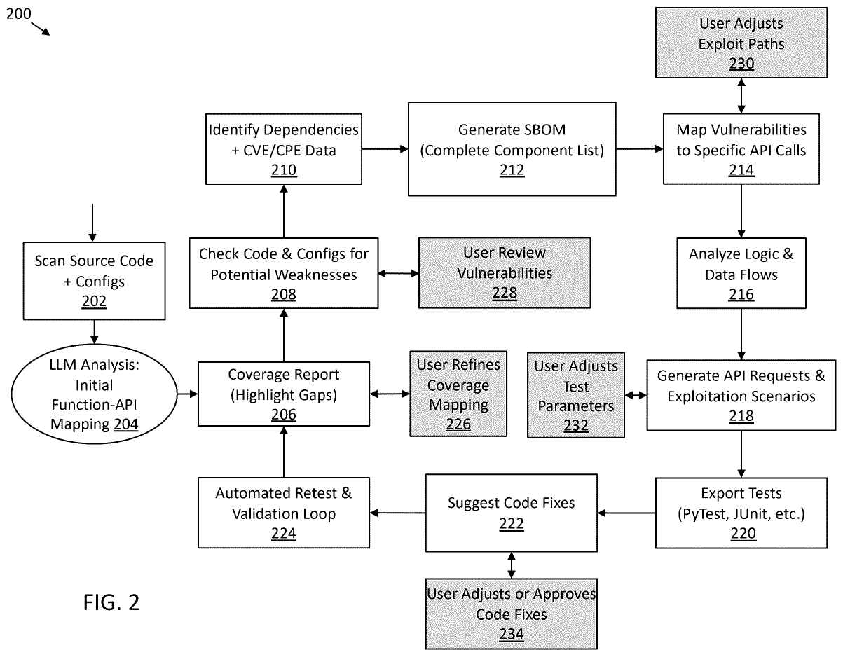

Aspects of the present invention discussed below are illustrated in FIG. 1, which shows an example user workflow with phase validation and coverage adjustments, and FIG. 2, which shows user interaction and coverage refinements.

### Phase 1: Source Code and Configuration Scan

This phase lays the groundwork by mapping each function in the source code and essential configurations to the exact application program interface (API) or application calls so that security tests have knowledge of every possible entry point, whether public or private. In an automated ingestion stage, the system collects all relevant source code files—including back-end services, front-end integrations, and configuration data—and also ingests server setup, load balancer rules, network configurations, and related environment settings to reflect the deployed context. The system then performs LLM-based analysis that uses a large language model to parse code syntax and semantics, identifying functions, classes, and logical blocks, distinguishing modules or microservices, cataloging their relationships, and linking them to environment factors such as containerization, cloud settings, or local operating-system details. An API-call correlation stage matches each discovered function or code segment with associated API endpoints (e.g., REST, GraphQL, gRPC, WebSockets, SOAP) and flags sections of code unlinked to any external call to surface hidden or unused logic. A coverage report is generated that maps code lines to relevant API calls or requests and highlights potential blind spots where code paths lack direct test coverage.

The phase concludes with user feedback and refinement. Security teams are invited to confirm or correct mappings, rename endpoints, or add external calls the scan missed, and a user-friendly interface enables expansion of coverage to help ensure that no function is overlooked and that coverage fidelity keeps pace with code evolution.

### Phase 2: Potential Vulnerabilities and Dependencies

With coverage in place, the tool hunts for weak spots and builds an inventory of everything the application uses, thriving on the data from Phase One without waiting for a perfect coverage map. An LLM-based vulnerability scan analyzes each line of code for unsafe patterns, suspicious function usage, and insecure default settings, and flags known dangerous calls or constructs, such as unsanitized user inputs or outdated encryption methods. A static-code weak-spot identification stage recognizes common pitfalls—including command injections, SQL injections, insecure file operations, and unsafe deserialization—and groups vulnerabilities by severity or category for triage.

A third-party dependency analysis cross-references common vulnerabilities and exposure databases and common platform enumeration (CVE/CPE) databases to identify any library or framework with known vulnerabilities, checks version compatibility, and highlights recommended updates or patches. The system generates a software bill of materials (SBOM) that lists all components from core frameworks to minor utility libraries, tracking each item's version and known security posture, and continuously catalogs changes by updating the SBOM whenever new dependencies or framework changes are detected, thereby maintaining a living document that reflects the application's evolving makeup.

### Phase 3: Connection Path Discovery

This phase merges Phase One's coverage insights with Phase Two's vulnerability findings to determine whether, and how, a discovered flaw can be reached through real API calls or user inputs. A data-correlation stage combines the coverage report with the SBOM and vulnerability-scan results, linking insecure code lines to specific endpoints that could trigger them and prioritizing vulnerabilities by ease of exploitation from the outside. A logical-condition analysis pinpoints gating checks, conditionals, and user-role verifications that an attacker must bypass or fulfill, and highlights user-flow scenarios and input-data shapes needed to move malicious payloads through the system.

An attack-path mapping stage visualizes complete routes from the external API boundary to the vulnerable function or code line, showing intermediate calls, microservice hops, and protocol transitions along the way. Edge-case identification surfaces less obvious logic flows, such as “dead code” that becomes reachable under rare configurations, and notifies teams if critical checks are missing or can be bypassed. Vulnerabilities are prioritized based on ease of exploitation and potential impact, setting the stage for generating tests that mirror real-world attack patterns.

### Phase 4: Security Test Generation

Using the confirmed connection paths, this phase produces precise test scripts that show exactly how an exploit might occur, demystifying exploitation for developers and security teams and enabling reproducible validation. Attack-scenario building leverages Phase Three data to create end-to-end sequences that illustrate, step by step, how an attacker might reach each vulnerability, and determines payload specifics such as injection strings, malformed JavaScript® object notation (JSON), or network-level manipulations. Minimal-exploit payload construction crafts the smallest workable attack package to reduce noise and false positives and ensures that each proof-of-concept exploit is reproducible and straightforward to confirm.

The system produces automated test scripts for frameworks like PyTest (i.e., an open-source testing framework for Python), JUnit (i.e., an open-source framework for writing and running unit tests in Java®), or other standard quality assurance (QA) tools, labeling each test with the corresponding lines of code or functions to make debugging direct and transparent. Tests are exported to version control or continuous integration and continuous delivery (CI/CD) pipelines so teams can schedule automated runs or integrate them with existing QA processes, with parallelization available to verify multiple vulnerabilities at once. A business-logic review presents exploit flows in human-readable form, mapping each step to source-code logic and allowing auditors or developers to validate or refine test parameters before formal acceptance.

### Phase 5: Fix Recommendations and Automated Feedback Loop

After vulnerabilities are confirmed and demonstrated, the system proposes solutions and tests them in real time, creating a virtuous cycle of detection, fixing and verification. Tailored code-fix suggestions highlight exact lines of code to modify and recommend alternative safe functions, up-to-date library versions, or better encryption methods; where appropriate, automated patch application can apply simple, low-risk fixes automatically subject to permission and environment constraints, with every change logged for review or rollback. A retest-and-validation stage re-runs the Phase Four exploit scripts to confirm elimination of each vulnerability and posts results to the project's issue tracker or CI pipeline with clear pass/fail indicators.

Iterative improvement uses LLM feedback to refine or expand recommended fixes if a patch fails validation and continues until all exploit paths are fully mitigated and re-tests pass. A knowledge-base update incorporates successful fixes into future scanning rules to prevent similar mistakes in new code releases and improves auto-detection capabilities for recurring vulnerability patterns, reinforcing continuous security hardening.

### Phase 6: Monitoring and Runtime Prevention

This phase tracks the live application environment and protects against in-progress threats by attaching non-invasively to processes or microservices to observe how functions are called, where memory is accessed, and which API endpoints are triggered. Memory hooking and process tracking instrument the runtime at the operating-system or container level, collect function-call footprints—including cases where rarely used code paths execute at high frequency—and use an LLM to correlate runtime telemetry with known vulnerability signatures or suspicious usage patterns. Behavioral profiling and anomaly detection build baselines of normal function-call sequences and resource-access patterns, identify anomalies such as unexpected calls to high-risk library methods, and match such anomalies with prior knowledge from Phases 1-5 to assess real-time threat potential.

Threat intervention and prevention flag suspicious activity for deeper inspection or automatic blocking and enforce policy-based actions, such as terminating processes that attempt to escalate privileges through previously flagged code paths, while notifying security teams or triggering protective mechanisms (e.g., quarantining containers). A feedback loop to the LLM feeds new runtime intelligence back to improve vulnerability models, refines coverage maps by revealing code paths never tested earlier, and expands test generation and fix recommendations to address newly discovered runtime gaps. Continuous adaptation updates the SBOM and external dependency checks if the monitored process loads new libraries or microservices on the fly, adjusts or creates new security tests for code paths that appear during runtime but were not present or mapped in earlier static phases, and evolves protective measures as new threats emerge or as code changes are deployed.

### Usage Scenarios

The technology supports multiple usage scenarios, including (1) fully automated security testing workflows for discovering vulnerabilities, (2) a white-box security audit methodology at 100% coverage with optional manual refinement in each phase, (3) complete automation for threat prevention and runtime protection, and (4) automated security code reviews integrated into CI/CD pipelines, leveraging previously uncovered vulnerabilities to continuously improve detection and defense.

### Scenario 1: Fully Automated Security Testing

A fully automated security testing mode may ingest source code, configuration files, and known threat databases to detect vulnerabilities without waiting for user feedback. In a microservices environment where services are implemented in different languages, an LLM phase may correlate each service's code paths with external endpoints, identify insecure dependencies, and check known common vulnerabilities and exposures (CVEs). The system may then generate API requests that confirm or deny suspected weaknesses. For example, when a possible SQL injection is detected in a Node.js service, the system may craft an HTTP request with a malicious payload. When the request succeeds, the system may capture proof of injection and present a detailed exploit scenario that maps requests to implicated code portions and external interfaces. Scans, validations, and fix recommendations may be merged directly back into the codebase with minimal manual effort, and subsequent executions may verify remediation.

### Scenario 2: White-box Security Audit at 100% Coverage

A white-box audit may combine automation with deep manual inspection by mapping each function call to corresponding external endpoints to reveal lines of code that remain untested or untraced. Security teams may drill into any function, see how the tool categorizes it, and adjust the mapping as needed. For example, in a large enterprise Java application, the tool may indicate that certain internal utility methods are not triggered by any external request. A security auditor may add test scenarios or custom calls to exercise those methods. These activities may produce a more accurate and transparent audit in which nothing is hidden and every function, class, and configuration setting is part of the overall picture. Teams may tweak the analysis, confirm findings, and refine the LLM's detection logic to improve coverage to or near 100% coverage.

Scenario 3: Fully Automated Threat Prevention and Runtime Protection

A runtime-protection mode may extend beyond static code scans by monitoring memory and live application processes for anomalies in real time. When a microservice in production begins calling a function that was not triggered during testing, memory-level analysis may detect the unexpected pattern and may flag it for immediate review. If the function can lead to privilege escalation or data exfiltration, the system may initiate policy-based intervention, for example blocking the call, quarantining a process or container, or alerting security personnel. The system may update internal models with observed behavior to refine prevention logic and to align coverage and test generation with runtime findings. This approach may deliver a protection layer that adapts to new threats using intelligence gathered from both static analysis and dynamic inspection.

Scenario 4: Automated Security Code Review in CI/CD Pipelines

A CI/CD review mode may integrate the tool into daily development workflows. When new code is pushed or a pull request is merged, the pipeline may trigger an LLM-based scan. The system may determine how a fresh module, for example a new payment component in a Python application, ties into existing data flows and may compare it against previously discovered vulnerabilities in similar modules. When patterns such as unvalidated user input or outdated library references are detected, warnings may be posted. The tool may automatically generate tests to reproduce the flaws and confirm impact. After fixes are applied, the pipeline may re-execute the tests to verify that the code is resilient against the same class of vulnerabilities. This arrangement may maintain a constant feedback loop that keeps security an active discipline inside the codebase.

FIG. 1 depicts an example user workflow 100 in which code and configuration assets are analyzed, coverage is built and refined, vulnerabilities are correlated to external interfaces, exploit tests are generated and validated, and runtime telemetry is aligned with validated paths to continuously harden the application. Each phase may include validation checkpoints and coverage adjustments that allow users to confirm mappings, triage findings and refine analysis before proceeding.

The workflow 100 begins with Source Code & Configurations (ingestion) 102, which may aggregate project source files, service/deployment descriptors, environment variables, and infrastructure settings for analysis. The ingested artifacts may be processed by LLM Analysis (Phase 1) 104, which parses structure and semantics to surface functions, classes, and logical blocks relevant to external interfaces. After LLM analysis and coverage report generation, a user-driven validation step (not depicted) may enable confirmation or correction of the identified functions and their mappings to API calls, including renaming endpoints and adding external calls the scan missed.

Next, Coverage Mapping (API ↔ Functions) 106 may establish explicit correspondences between external endpoints (e.g., REST, GraphQL, gRPC, WebSockets, SOAP) and internal code segments, exposing exercised and unexercised logic and highlighting blind spots. This phase may include a coverage-adjustment step, enabling users to refine mappings (e.g., add missing endpoints, correct associations, or elevate priority for rarely exercised paths) before downstream correlation and testing.

The workflow 100 may then proceed to Check CVE/CPE & 3rd-Party Libraries 110, which identifies third-party components and cross-references them against vulnerability sources, and to Generate SBOM 112, which compiles a software bill of materials (SBOM) with component versions and security posture. Users may validate dependency findings and update coverage to reflect library-specific entry points or modules implicated by the mapping.

Using the combined coverage and SBOM context, Map Vulnerabilities to API Calls 114 may associate suspected or discovered weaknesses with specific external entry points capable of reaching implicated code segments. Check Logic & Data Flows (if/else, validations) 116 may examine gating conditions, validations, role/permission checks, and branching logic to determine exploitability and prerequisites. Results of these phases may undergo validation, allowing users to triage issues, confirm reachability, and adjust coverage (e.g., mark paths as high-risk or add missing guards) prior to test construction.

When exploit paths are confirmed, Auto-Build Test Sequences 118 may construct end-to-end sequences that reproduce the weaknesses, and Export Tests (PyTest, JUnit, etc.) 120 packages the end-to-end sequences for execution within standard test frameworks. Users may validate test scope and parameters and apply coverage adjustments to ensure the tests target the correct endpoints and code paths. Suggest Code Fixes 122 may propose targeted remediations tied to implicated lines or functions. Automated Retest & Feedback Loop 124 may execute the exported tests, integrate pass/fail results into the workflow record, and provide an explicit validation checkpoint where users can confirm remediation effectiveness and update coverage annotations (e.g., mark paths as remediated or requiring further investigation).

Operational telemetry may be aligned through Runtime Monitoring (Memory & Process) 126, which instruments the application at the OS/container/process level to collect function-call traces, memory-access patterns, and resource-usage signals. Validated exploit traces and re-test outcomes from Automated Retest & Feedback Loop 124 may be incorporated into Runtime Monitoring 126 so that live telemetry is collected where residual or intermittent risk has been demonstrated. In addition, the coverage map from Coverage Mapping (API ↔ Functions) 106 may be used to configure runtime instrumentation by identifying functions/endpoints, rarely exercised code paths, and unmapped regions that merit focused behavioral probes and memory checks. Telemetry from Runtime Monitoring (Memory & Process) 126 may further inform earlier phases (e.g., recalibrating coverage or updating dependency/SBOM context) to sustain alignment between static analysis and observed behavior (not depicted).

While FIG. 1 presents a nominal sequence, certain steps of user workflow 100 may proceed iteratively or in parallel. Phase-specific validation and coverage-adjustment steps can be invoked at any point, enabling users to refine mappings, prioritize investigations, and synchronize test generation and runtime instrumentation with the evolving codebase and environment.

FIG. 2 depicts a workflow 200 that begins with Scan Source Code+Configs 202, which may ingest project repositories, service and deployment descriptors, environment variables and infrastructure settings. The ingested artifacts may be processed by LLM Analysis: Initial Function—API Mapping 204 to surface functions, classes, and logical blocks and to correlate them with external endpoints. A Coverage Report (Highlight Gaps) 206 may be produced to identify unlinked or untested code paths and to expose blind spots in function- endpoint mappings. The workflow 200 may then continue to Check Code & Configs for Potential Weaknesses 208 to examine code and configuration assets for potential issues.

Results from Coverage Report (Highlight Gaps) 206 and Check Code & Configs for Potential Weaknesses 208 may be provided to Identify Dependencies +CVE/CPE Data 210, which may enumerate third-party libraries and frameworks, record component identifiers and versions, and may cross-reference those versions against vulnerability sources, including CVE and CPE databases, to surface known issues and recommended updates. Generate SBOM (Complete Component List) 212 may compile a software bill of materials (SBOM) that lists components, versions and security posture, and may be updated as dependencies change so that downstream mapping and validation reflect the current application state.

Using this context, Map Vulnerabilities to Specific API Calls 214 may associate discovered or suspected weaknesses with concrete external entry points. Analyze Logic & Data Flows 216 may evaluate gating checks and conditionals to determine exploitability and prerequisites for traversing vulnerable paths. When exploit paths are identified, Generate API Requests & Exploitation Scenarios 218 may compose requests and end-to-end sequences that reproduce the suspected weaknesses. Export Tests (PyTest, JUnit, etc.) 220 may package the end-to-end sequences for execution in standard test frameworks. Suggest Code Fixes 222 may provide proposed remediations, and Automated Retest & Validation Loop 224 may execute exported tests and integrate pass or fail outcomes for iterative improvement. Validation outcomes, retest traces, coverage deltas and related telemetry may be provided from Automated Retest & Validation Loop 224 to Coverage Report (Highlight Gaps) 206 in order to ensure that coverage updates and retest insights are reflected in subsequent reporting.

The workflow may incorporate multiple user-driven refinement points with bidirectional interactions between user-facing stages and the corresponding analysis stages. Suggest Code Fixes 222 may be bidirectionally coupled with the User Adjusts or Approves Code Fixes stage 234, such that proposed remediations, code-change recommendations, and fix parameters may be provided to stage 234 for review or approval and, conversely, user-approved revisions and adjustment constraints may be provided back to stage 222 to refine suggested code changes prior to validation. Check Code & Configs for Potential Weaknesses 208 may be bidirectionally coupled with the User Review Vulnerabilities stage 228, allowing detected issues to be triaged and prioritized by the user and, in the opposite direction, user prioritization may prompt targeted rescans or focused examination of implicated assets. Coverage Report (Highlight Gaps) 206 may be bidirectionally coupled with the User Refines Coverage Mapping stage 226, whereby gap reporting may drive updates to function-endpoint correlations and those updates may be reflected in subsequent coverage reporting. Generate API Requests & Exploitation Scenarios 218 may be bidirectionally coupled with the User Adjusts Test Parameters stage 232 so that user-level tuning of payloads, thresholds, top-N selections, timing, and environment flags may guide scenario generation, with those refinements optionally propagated to downstream test artifacts. Map Vulnerabilities to Specific API Calls 214 may be bidirectionally coupled with the User Adjusts Exploit Paths stage 230, so that the association of weaknesses with concrete entry points may inform the user's exploit-path construction and refinement, and user adjustments to those paths may in turn update the underlying mappings and prioritization.

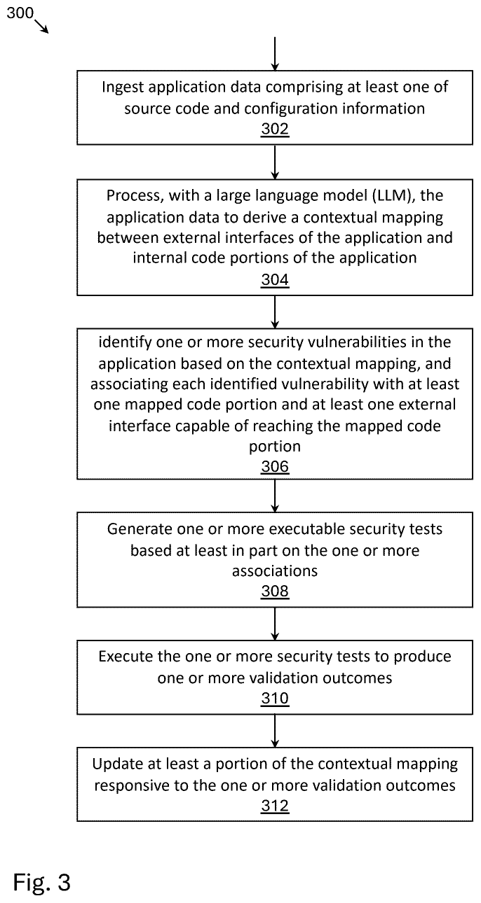

FIG. 3 depicts a computer-implemented method 300 for analyzing an application to improve security using a contextual mapping between external interfaces and internal code portions. In step 302, one or more processors may ingest application data comprising at least one of source code and configuration information, and may further collect environment descriptors such as deployment manifests, API gateway settings, load-balancer rules, container or operating system parameters, and service topology metadata so that both static logic and deployed context are available to analysis. The ingestion may span multiple microservices implemented in different programming languages and may normalize file structures, project layouts, and build artifacts to a common intermediate representation. In certain embodiments, the ingestion may include enumerating dependencies referenced by the application and recording component identifiers and versions as a software bill of materials (SBOM), thereby providing a foundation for later correlation with vulnerability sources and for aligning code-level findings with package-level risk. The system may preserve provenance and linkage between artifacts, for example mapping a configuration flag to a specific module or endpoint, so that downstream mapping, testing, and remediation remain traceable to their originating assets.

In step 304, a large language model (LLM) may process the ingested application data to derive a contextual mapping between external interfaces of the application and internal code portions of the application. The mapping may associate functions, classes, logical blocks, or individual lines of code with addressable endpoints or other protocol surfaces, including REST, GraphQL, gRPC, WebSockets, or SOAP routes. In some embodiments, the LLM may infer cross-service call flows and correlate intermediate hops, microservice boundaries, or message-queue interactions with implicated code segments, producing coverage reports that highlight unlinked or under-tested logic. The mapping may include gating conditions such as validations, role or permission checks, and branching paths that influence reachability from an external interface to a target code portion, and may accept user input to adjust or refine associations where domain-specific semantics or custom frameworks are present. The resulting context may serve as a living model that informs subsequent vulnerability identification and test construction, while remaining amenable to manual refinement for high coverage.

In step 306, the system may identify one or more security vulnerabilities based on the contextual mapping and may associate each identified vulnerability with at least one mapped code portion and at least one external interface capable of reaching that mapped portion, thereby establishing an exploit path. Vulnerability detection may include recognizing patterns indicative of insecure logic such as unsanitized inputs, unsafe deserialization, insecure file operations, or outdated cryptographic usage, and may correlate these findings with SBOM entries to surface known issues through common vulnerabilities and exposures (CVE) and common platform enumeration (CPE) sources. The association may further capture prerequisites and constraints, such as specific request shapes, authentication states, feature flags, or data-flow invariants, that may be satisfied to traverse from the interface to the vulnerable code, and may rank findings by ease of exploitation and potential impact. User-driven triage may be incorporated to confirm, prioritize, or suppress findings and to refine exploit path details prior to test generation.

In step 308, one or more executable security tests may be automatically generated based at least in part on the foregoing associations, with each test designed to reproduce an exploit path reachable via at least one external interface. Test construction may include building minimal exploitable payloads that confirm a vulnerability while reducing false positives, and may annotate requests with parameter choices, headers, timing, or sequencing needed to traverse validations or branching logic. The generated artifacts may be exportable to multiple testing frameworks, such as Python-based frameworks like PyTest or Java-based frameworks like JUnit, and may embed references to corresponding functions, classes, or lines of code to streamline debugging and remediation. In some embodiments, the system may produce end-to-end sequences across microservice boundaries, may incorporate environment flags or top-N selections for payload variants, and may accept user adjustments to test parameters so that exploitation scenarios align with real deployment constraints.

In step 310, the one or more security tests may be executed to produce one or more validation outcomes, which may include pass or fail indicators, captured evidence of successful exploitation, coverage deltas, and traces showing how requests traversed gating conditions to reach the vulnerable code. Execution may be integrated into continuous integration and continuous delivery (CI/CD) pipelines so that outcomes are recorded alongside build artifacts and issue trackers, enabling repeatable validation as code or configuration changes are introduced. The system may instrument runtime processes to collect telemetry during test execution, such as function-call traces, memory-access patterns, resource-usage signals, or endpoint triggers, and may correlate this telemetry with the contextual mapping to strengthen confidence in reachability and impact. Where appropriate, the execution environment may enforce policy-based interventions, for example alerting a security control or quarantining a container, when a test demonstrates high-risk behavior, while preserving logs and artifacts required for audit and follow-up.

In step 312, at least a portion of the contextual mapping may be updated responsive to the validation outcomes, and the update may incorporate user input to adjust or refine associations and coverage where appropriate. The mapping may be revised to mark exploit paths as confirmed, to elevate or suppress risk annotations, and to incorporate additional code portions observed at runtime but previously absent or under-covered in static analysis. In some embodiments, the system may generate targeted remediation recommendations indicating code changes associated with identified vulnerabilities, and may re-execute the tests after application of a remediation to confirm elimination of the exploit path; results of the re-execution may further drive mapping updates and knowledge-base improvements so that recurring vulnerability patterns are more readily detected in future scans. The feedback loop may extend to SBOM and dependency context, updating component versions, re-checking CVE and CPE posture, and adjusting external-interface instrumentation, so that the overall model continually adapts as code evolves and as operational telemetry reveals new or rare paths.

As used herein, the term “external interfaces” refers to any mechanism by which an application is interacted with from outside the application, including but not limited to addressable endpoints (e.g., HTTP or RPC routes), API gateways, protocol surfaces (for example, REST, GraphQL, gRPC, WebSockets, or SOAP), message queues, webhooks, and other externally callable interaction surfaces. In certain embodiments, “external interfaces” include addressable endpoints implementing the foregoing protocols; references in this specification to “external endpoints” are to be understood as a subset of “external interfaces” unless the context indicates otherwise.

As used herein, Representational State Transfer (REST) refers to an architectural style for networked applications in which resources are addressed by uniform resource identifiers (URIs) and are manipulated via a uniform, stateless interface (e.g., HTTP methods), with resource representations commonly encoded as JSON or XML.

As used herein, Graph Query Language (GraphQL) refers to a query language and execution runtime for application programming interfaces (APIs) in which a typed schema declares object types, fields, arguments, and relationships, and clients specify exactly which fields to retrieve or modify via operations including queries (read), mutations (write), and subscriptions (event streams). GraphQL requests are commonly sent to a single addressable endpoint (e.g., HTTP POST) with a JSON payload containing a query document and optional variables, and responses are typically JSON objects comprising a data section and, when applicable, an errors section. A GraphQL server resolves field selections through resolver functions that may call backend services, databases, or other components, with optional middleware enforcing validation, authorization, rate limiting, or depth/complexity controls; schemas are generally introspectable to expose available types and operations. Within the contextual mapping described herein, GraphQL field selections and nested resolver chains may be associated with corresponding internal code portions so that reachability, gating conditions (e.g., auth checks), and payload shapes (e.g., variables, fragments) are captured for vulnerability identification and test generation.

As used herein, gRPC Remote Procedure Calls (gRPC) refers to an RPC framework and protocol in which a typed service contract declares services and RPC methods, request and response message schemas, and streaming semantics, and clients invoke methods on a single addressable endpoint over application-layer transports (commonly HTTP/2). In typical deployments, interface definition language (IDL) files (e.g., Protocol Buffers) specify message types and service method signatures; code generation produces client and server stubs across multiple languages. A gRPC message exchange may be unary or streaming (server-streaming, client-streaming, bidirectional), may include metadata headers (e.g., authentication tokens, routing hints), and returns method-level status codes with optional trailers. Implementations often employ transport security and authentication (e.g., TLS/mTLS, OAuth/JWT), and may incorporate interceptors/middleware for validation, authorization, rate limiting, or observability.

As used herein, WebSockets refers to a full-duplex, bidirectional communication protocol that establishes a persistent channel between a client and a server over a single TCP connection, typically initiated via an HTTP(S) “Upgrade” handshake and thereafter exchanging framed messages without per-message HTTP overhead. A WebSocket session may negotiate optional subprotocols (e.g., graphql-ws), use text or binary frames, and employ control frames (e.g., ping/pong, close) for health-checking and orderly teardown. Implementations commonly integrate transport security (TLS), origin checks and authentication/authorization middleware; server or proxy configurations may enforce limits on message size, connection lifetime, and concurrency, and may provide observability hooks for routing, rate limiting, or anomaly detection.

As used herein, Simple Object Access Protocol (SOAP) refers to a protocol for exchanging structured information in web services, typically using XML envelopes over application-layer transports (e.g., HTTP, SMTP). A SOAP message may include an envelope, optional header entries (e.g., authentication or routing metadata), and a body that carries request or response payloads defined by a service contract (e.g., operations and message parts described in a Web Services Description Language (WSDL) interface).

As used herein, a software bill of materials (SBOM) refers to a structured list of software components, dependencies, and versions present in an application or service, suitable for cross-reference against vulnerability sources.

As used herein, Common Vulnerabilities and Exposures (CVE) refers to a catalog of publicly disclosed cybersecurity vulnerabilities; Common Platform Enumeration (CPE) refers to a structured naming scheme for IT systems, software, and packages used to identify affected components in vulnerability sources.

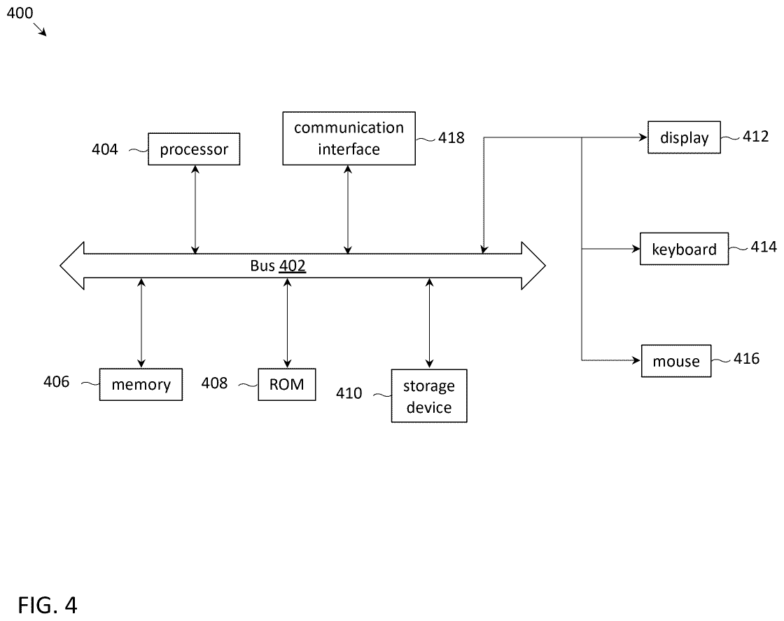

As is apparent from the foregoing discussion, aspects of the present invention involve the use of various computer systems and computer readable storage media having computer-readable instructions stored thereon. FIG. 4 provides an example of a system 400 that may be representative of any of the computing systems discussed herein. Examples of system 400 may include a smartphone, a desktop, a laptop, a mainframe computer, an embedded system, etc. Note, not all of the various computer systems have all of the features of system 400. For example, certain ones of the computer systems discussed above may not include a display inasmuch as the display function may be provided by a client computer communicatively coupled to the computer system or a display function may be unnecessary. Such details are not critical to the present invention.

System 400 includes a bus 402 or other communication mechanism for communicating information, and a processor 404 coupled with the bus 402 for processing information. Computer system 400 also includes a main memory 406, such as a random access memory (RAM) or other dynamic storage device, coupled to the bus 402 for storing information and instructions to be executed by processor 404. Main memory 406 also may be used for storing temporary variables or other intermediate information during execution of instructions to be executed by processor 404. Computer system 400 further includes a read only memory (ROM) 408 or other static storage device coupled to the bus 402 for storing static information and instructions for the processor 404. A storage device 410, for example a hard disk, flash memory-based storage medium, or other storage medium from which processor 404 can read, is provided and coupled to the bus 402 for storing information and instructions (e.g., operating systems, applications programs and the like).

Computer system 400 may be coupled via the bus 402 to a display 412, such as a flat panel display, for displaying information to a computer user. An input device 414, such as a keyboard including alphanumeric and other keys, may be coupled to the bus 402 for communicating information and command selections to the processor 404. Another type of user input device is cursor control device 416, such as a mouse, a trackpad, or similar input device for communicating direction information and command selections to processor 404 and for controlling cursor movement on the display 412. Other user interface devices, such as microphones, speakers, etc. are not shown in detail but may be involved with the receipt of user input and/or presentation of output.

The processes referred to herein may be implemented by processor 404 executing appropriate sequences of computer-readable instructions contained in main memory 406. Such instructions may be read into main memory 406 from another computer-readable medium, such as storage device 410, and execution of the sequences of instructions contained in the main memory 406 causes the processor 404 to perform the associated actions. In alternative embodiments, hard-wired circuitry or firmware-controlled processing units may be used in place of or in combination with processor 404 and its associated computer software instructions to implement the invention. The computer-readable instructions may be rendered in any computer language.

In general, all of the above process descriptions are meant to encompass any series of logical steps performed in a sequence to accomplish a given purpose, which is the hallmark of any computer-executable application. Unless specifically stated otherwise, it should be appreciated that throughout the description of the present invention, use of terms such as “processing”, “computing”, “calculating”, “determining”, “displaying”, “receiving”, “transmitting” or the like, refer to the action and processes of an appropriately programmed computer system, such as computer system 400 or similar electronic computing device, that manipulates and transforms data represented as physical (electronic) quantities within its registers and memories into other data similarly represented as physical quantities within its memories or registers or other such information storage, transmission or display devices.

Computer system 400 also includes a communication interface 418 coupled to the bus 402. Communication interface 418 may provide a two-way data communication channel with a computer network, which provides connectivity to and among the various computer systems discussed above. For example, communication interface 418 may be a local area network (LAN) card to provide a data communication connection to a compatible LAN, which itself is communicatively coupled to the Internet through one or more Internet service provider networks. The precise details of such communication paths are not critical to the present invention. What is important is that computer system 400 can send and receive messages and data through the communication interface 418 and in that way communicate with hosts accessible via the Internet. It is noted that the components of system 400 may be located in a single device or located in a plurality of physically and/or geographically distributed devices.

In one embodiment, a computer-implemented method analyzes an application to improve its security. The method comprises ingesting, by one or more processors, application data comprising at least one of source code and configuration information; processing, with a large language model (LLM), the application data to derive a contextual mapping between external interfaces of the application and internal code portions of the application; identifying, by the one or more processors, one or more security vulnerabilities in the application based on the contextual mapping, and associating each identified vulnerability with at least one mapped code portion and at least one external interface capable of reaching the mapped code portion; generating, by the one or more processors, one or more executable security tests based at least in part on the one or more associations; executing, by the one or more processors, the one or more executable security tests to produce one or more validation outcomes; and updating, by the one or more processors, at least a portion of the contextual mapping responsive to the one or more validation outcomes.

In one embodiment, the method further comprises receiving user input to adjust or refine the contextual mapping.

In one embodiment, deriving the contextual mapping comprises associating one or more of functions, classes, logical blocks, or lines of code with the external interfaces exposed by the application.

In one embodiment, identifying the one or more security vulnerabilities comprises detecting patterns indicative of insecure logic including at least one of unsanitized inputs, unsafe deserialization, insecure file operations, or outdated cryptographic usage.

In one embodiment, the method further comprises enumerating dependencies referenced by the application and generating a software bill of materials (SBOM) listing component identifiers and versions.

In one embodiment, the method further comprises cross-referencing items in the SBOM against vulnerability sources to identify known issues, including sources providing common vulnerabilities and exposures (CVE) and common platform enumeration (CPE) data.

In one embodiment, associating each identified vulnerability with at least one mapped code portion and at least one external interface comprises linking the identified vulnerability to at least one of the external interfaces capable of reaching the mapped code portion associated with the identified vulnerability to establish an exploit path.

In one embodiment, the method further comprises evaluating gating conditions applicable to the exploit path, including at least one of validations, role or permission checks, and branching logic.

In one embodiment, the one or more executable security tests reproduce an exploit path associated with at least one of the identified vulnerabilities, the exploit path being reachable via at least one of the external interfaces.

In one embodiment, the executable security tests include minimal exploitable payloads selected to confirm the at least one identified vulnerability while reducing false positives.

In one embodiment, the executable security tests are exportable to multiple testing frameworks including at least one of a Python-based framework or a Java-based framework.

In one embodiment, the method further comprises integrating execution of the executable security tests into a continuous integration/continuous delivery (CI/CD) pipeline and recording one or more pass/fail outcomes for at least one of the one or more identified vulnerabilities.

In one embodiment, the method further comprises generating targeted remediation recommendations indicating code changes associated with at least one of the one or more identified vulnerabilities.

In one embodiment, the method further comprises re-executing the one or more executable security tests after application of a remediation recommendation and updating the contextual mapping responsive to one or more outcomes of the re-execution.

In one embodiment, the method further comprises instrumenting runtime processes to collect telemetry including at least one of function-call traces, memory-access patterns, resource-usage signals or endpoint triggers.

In one embodiment, the method further comprises correlating, with the LLM, the telemetry to the contextual mapping and the one or more validation outcomes in order to detect anomalies indicative of suspicious or malicious behavior.

In one embodiment, the method further comprises initiating a policy-based intervention responsive to detection of an anomaly, the policy-based intervention comprising at least one of alerting a security control, quarantining a process or container, or blocking invocation of at least one of the external interfaces.

In one embodiment, the method further comprises feeding runtime intelligence back to the LLM to refine the contextual mapping and to generate additional or revised one or more executable security tests for code paths observed at runtime but absent or under-covered in static analysis.

In one embodiment, the external interfaces include addressable endpoints exposed via application protocols including at least one of Representational State Transfer (REST), Graph Query Language (GraphQL), gRPC Remote Procedure Calls (gRPC), WebSockets, or Simple Object Access Protocol (SOAP).

In one embodiment, a non-transitory computer-readable medium comprising instructions that, when executed by a processor, cause the processor to: ingest application data comprising at least one of source code and configuration information; process, with a large language model (LLM), the application data to derive a contextual mapping between external interfaces of the application and internal code portions of the application; identify one or more security vulnerabilities in the application based on the contextual mapping, and associate each identified vulnerability with at least one mapped code portion and at least one external interface capable of reaching the mapped code portion; generate one or more executable security tests based at least in part on the one or more associations; execute the one or more executable security tests to produce one or more validation outcomes; and update at least a portion of the contextual mapping responsive to the one or more validation outcomes.

Thus, an LLM-based contextual mapping for application security testing with automated test generation has been described. It is to be understood that the above-description is intended to be illustrative, and not restrictive. Many other embodiments will be apparent to those of skill in the art upon reviewing the above description. The scope of the invention should, therefore, be determined with reference to the appended claims, along with the full scope of equivalents to which such claims are entitled.

What is claimed is:

1. A computer-implemented method for analyzing an application to improve its security, the method comprising:
ingesting, by one or more processors, application data comprising at least one of source code and configuration information;
processing, with a large language model (LLM), the application data to derive a contextual mapping between external interfaces of the application and internal code portions of the application;
identifying, by the one or more processors, one or more security vulnerabilities in the application based on the contextual mapping, and associating each identified vulnerability with at least one mapped code portion and at least one external interface capable of reaching the mapped code portion;
generating, by the one or more processors, one or more executable security tests based at least in part on the one or more associations;
executing, by the one or more processors, the one or more executable security tests to produce one or more validation outcomes; and
updating, by the one or more processors, at least a portion of the contextual mapping responsive to the one or more validation outcomes.

2. The method of claim 1, further comprising receiving user input to adjust or refine the contextual mapping.

3. The method of claim 1, wherein deriving the contextual mapping comprises associating one or more of functions, classes, logical blocks, or lines of code with the external interfaces exposed by the application.

4. The method of claim 1, wherein identifying the one or more security vulnerabilities comprises detecting patterns indicative of insecure logic including at least one of unsanitized inputs, unsafe deserialization, insecure file operations, or outdated cryptographic usage.

5. The method of claim 1, further comprising enumerating dependencies referenced by the application and generating a software bill of materials (SBOM) listing component identifiers and versions.

6. The method of claim 5, further comprising cross-referencing items in the SBOM against vulnerability sources to identify known issues, including sources providing common vulnerabilities and exposures (CVE) and common platform enumeration (CPE) data.

7. The method of claim 1, wherein associating each identified vulnerability with at least one mapped code portion and at least one external interface comprises linking the identified vulnerability to at least one of the external interfaces capable of reaching the mapped code portion associated with the identified vulnerability to establish an exploit path.

8. The method of claim 7, further comprising evaluating gating conditions applicable to the exploit path, including at least one of validations, role or permission checks, and branching logic.

9. The method of claim 1, wherein the one or more executable security tests reproduce an exploit path associated with at least one of the identified vulnerabilities, the exploit path being reachable via at least one of the external interfaces.

10. The method of claim 9, wherein the executable security tests include minimal exploitable payloads selected to confirm the at least one identified vulnerability while reducing false positives.
